(19) United States
(12) Patent Application Publication
(10) Pub. No.: US 2023/0036235 A1
(43) Pub. Date: Feb. 2, 2023

(54) METHOD AND APPARATUS FOR HANDLING CONFLICT BETWEEN IDENTIFIERS

(71) Applicant: ELECTRONICS AND TELECOMMUNICATIONS RESEARCH INSTITUTE, Daejeon (KR)

(72) Inventors: Man Ho PARK, Daejeon (KR); Hee Sang CHUNG, Daejeon (KR)

(73) Assignee: ELECTRONICS AND TELECOMMUNICATIONS RESEARCH INSTITUTE, Daejeon (KR)

(21) Appl. No.: 17/862,268

(22) Filed: Jul. 11, 2022

(30) Foreign Application Priority Data
Jul. 15, 2021 (KR) 10-2021-0092566

(51) Int. Cl. H04W 76/23; H04W 76/11; H04W 76/18

(52) U.S. Cl. CPC H04W 76/23; H04W 76/11; H04W 76/18; H04W 88/04

(57) ABSTRACT

A method of handling an identifier conflict in a relay communication access service comprises receiving a relay communication request message from a remote terminal, obtaining an identifier of the remote terminal from the relay communication request message, assigning preliminary identifiers for identifier conflict handling based on the identifier of the remote terminal, and transmitting a relay communication response message including preliminary identifier information for the assigned preliminary identifiers to the remote terminal.

### CROSS-REFERENCE TO RELATED APPLICATIONS

This application claims priority to Korean Patent Application No. 10-2021-0092566, filed on Jul. 15, 2021, with the Korean Intellectual Property Office (KIPO), the entire contents of which are hereby incorporated by reference.

### BACKGROUND

### 1. Technical Field

The present disclosure relates to wireless communication, and more particularly, to a method and an apparatus for efficiently resolving a problem of an identifier conflict between terminals in providing a relay communication access function through wireless direct communications.

### 2. Related Art

In the case of direct communications (e.g., device-to-device (D2D) or sidelink) and relay communications using the 5G new radio (NR) services, especially on a Moving Network (MN) service that mainly targets high-speed moving objects such as vehicles, participating vehicles may frequently leave a relay service zone, or new vehicles may frequently appear in the relay service zone. In this case, since processes of configuring, changing, and terminating relay communication paths occur quickly and frequently for a certain period of time within the relay service zone, a problem may occur in normally providing relay communication services.

In such the situation, if a procedure of handling a terminal identifier conflict problem related to the relay service is complicated or there is a delay in the handling, a service reliability for a terminal participating in the relay service may be greatly damaged and a service quality therefor may deteriorate. In particular, when the procedure of handling the identifier conflict problem is not efficiently performed, the overall relay system performance may be deteriorated and service reliability may be deteriorated. As described above, there is a need for an effective and reliable method for handling an identifier conflict problem of a relay terminal in the MN service environment using a millimeter wave (mmWave).

### SUMMARY

Accordingly, exemplary embodiments of the present disclosure are directed to providing a method and an apparatus for efficiently resolving a problem of identifier conflict between moving network (MN) terminals using a mmWave band, which are involved in a relay communication service, in providing direct communications and the relay communication service therebetween.

According to a first exemplary embodiment of the present disclosure, a method of handling an identifier conflict in a relay communication access service using wireless direct communications may comprise: receiving a relay communication request message from a remote terminal; obtaining an identifier of the remote terminal from the relay communication request message; assigning preliminary identifier(s) for identifier conflict handling based on the identifier of the remote terminal; and transmitting a relay communication response message including preliminary identifier information for the assigned preliminary identifier(s) to the remote terminal.

The method may further comprise: receiving a relay communication message from the remote terminal; and identifying whether the identifier of the remote terminal included in the relay communication message matches one preliminary identifier selected from among the assigned preliminary identifier(s).

The method may further comprise, after the identifying, releasing reservations for remaining preliminary identifier(s) excluding the matched preliminary identifier among the assigned preliminary identifier(s).

The method may further comprise: receiving an identifier update message from the remote terminal; determining whether the a to-be-updated identifier of the remote terminal included in the identifier update message overlaps an identifier of another terminal in another relay service; in response to determining that the to-be-updated identifier overlaps an identifier of another terminal, assigning preliminary update identifiers based on the to-be-updated identifier; and transmitting, to the remote terminal, a message including preliminary update identifier information for the assigned preliminary update identifier(s) as a response message or a rejection message to the identifier update message.

The method may further comprise: receiving a relay communication message from the remote terminal; and identifying whether the identifier of the remote terminal included in the relay communication message matches one preliminary update identifier selected from among the assigned preliminary update identifier(s).

The method may further comprise, after the identifying, releasing reservations for remaining preliminary update identifier(s) excluding the matched preliminary updated identifier among the assigned preliminary update identifier(s).

The relay communication response message, the response message, or the rejection message may include additional fields for the preliminary identifier information.

The preliminary identifier may be a connection layer identifier of the remote terminal and may be composed of an identifier of an upper layer which is a Layer 2 (L2) and an identifier of a physical layer which is a lower layer.

According to a second exemplary embodiment of the present disclosure, a method of handling an identifier conflict in a relay communication access service using wireless direct communications may comprise: receiving a relay communication request message from a remote terminal; transmitting a relay communication response message to the remote terminal based on an identifier of the remote terminal obtained from the relay communication request message; receiving an identifier update message from the remote terminal during a relay service for the remote terminal; determining whether a to-be-updated identifier of the remote terminal included in the identifier update message is duplicate with an identifier of another terminal in another relay service; in response to determining that the to-be-updated identifier overlaps an identifier of another terminal, assigning preliminary update identifier(s) based on the to-be-updated identifier; and transmitting, to the remote terminal, a message including preliminary update identifier information for the assigned preliminary update identifier(s) as a response message to the identifier update message.

The method may further comprise: receiving a relay communication message from the remote terminal within a predetermined time after transmitting the message including the preliminary update identifier information to the remote terminal; and identifying whether the identifier of the remote terminal included in the relay communication message matches one preliminary update identifier selected from among the assigned preliminary update identifier(s).

The method may further comprise, after the identifying, releasing reservations for remaining preliminary update identifier(s) excluding the matched preliminary updated identifier among the assigned preliminary update identifier(s).

According to a third exemplary embodiment of the present disclosure, a method of handling an identifier conflict, performed by a remote terminal, in a relay communication access service using wireless direct communications may comprise: transmitting a relay communication request message to a relay terminal; receiving, from the relay terminal, a relay communication response message including preliminary identifier information for preliminary identifier(s) assigned for identifier conflict handling based on an identifier of the remote terminal; selecting one preliminary identifier from among the preliminary identifier(s) according to a preconfigured scheme; and transmitting a relay communication message to the relay terminal based on the selected preliminary identifier.

The relay communication response message may include additional fields for the preliminary identifier information.

The preliminary identifier may be a connection layer identifier of the remote terminal and may be composed of an identifier of an upper layer which is a Layer 2 (L2) and an identifier of a physical layer which is a lower layer.

According to a fourth exemplary embodiment of the present disclosure, an apparatus for handling an identifier conflict in a relay communication access service using wireless direct communications may comprise a processor; instructions executable by the processor; and a memory storing the instructions, wherein when executed by the processor, the instructions cause the processor to: receive a relay communication request message from a remote terminal; obtain an identifier of the remote terminal from the relay communication request message; assign preliminary identifier(s) for identifier conflict handling based on the identifier of the remote terminal; and transmit a relay communication response message including preliminary identifier information for the assigned preliminary identifier(s) to the remote terminal.

The instructions may further cause the processor to: receive a relay communication message from the remote terminal; and identify whether the identifier of the remote terminal included in the relay communication message matches one preliminary identifier selected from among the assigned preliminary identifier(s).

The instructions may further cause the processor to, after the identifying, release reservations for remaining preliminary identifier(s) excluding the matched preliminary identifier among the assigned preliminary identifier(s).

The instructions may further cause the processor to: receive an identifier update message from the remote terminal; determine whether the a to-be-updated identifier of the remote terminal included in the identifier update message overlaps an identifier of another terminal in another relay service; in response to determining that the to-be-updated identifier overlaps an identifier of another terminal, assign preliminary update identifiers based on the to-be-updated identifier; and transmit, to the remote terminal, a message including preliminary update identifier information for the assigned preliminary update identifier(s) as a response message or a rejection message to the identifier update message.

The instructions may further cause the processor to: receive a relay communication message from the remote terminal; and identify whether the identifier of the remote terminal included in the relay communication message matches one preliminary update identifier selected from among the assigned preliminary update identifier(s).

The instructions may further cause the processor to, after the identifying, release reservations for remaining preliminary update identifier(s) excluding the matched preliminary updated identifier among the assigned preliminary update identifier(s).

According to the exemplary embodiments of the present disclosure, in a relay communication service scheme providing an identifier configuration function, when a remote terminal participating in a relay service is provided with the relay service through a relay terminal included commonly in different service zones, the relay terminal can assign preliminary identifiers by using not only information on identifiers obtainable in a local service zone to which the remote terminal belongs, but also information on identifiers obtainable in other service zones. Accordingly, the possibility of identifier conflict in the remote terminal can be reduced, and the possibility of delay due to the conventional scheme of simply reconfiguring identifiers for resolving the identifier conflict can be reduced.

In addition, according to the exemplary embodiments of the present disclosure, an identification error and a path configuration error for communication terminals participating in the relay service that may occur due to an indirect identifier conflict can be solved, and the reliability and overall system efficiency of the direct relay service between the terminals can be improved. In addition, according to the exemplary embodiments of the present disclosure, a processing delay that may occur in the process of configuring relay communication or providing the relay service can be prevented, and a transmission error due to the identifier conflict can be prevented. Accordingly, it is possible to obtain the effect of improving the connectivity of the terminal using relay communication and increasing the quality of the relay service, thereby increasing the overall efficiency of the system.

### BRIEF DESCRIPTION OF DRAWINGS

FIG. 1 is a conceptual configuration diagram of a network relay communication service based on the 5G NR technology.

FIG. 2 is a conceptual configuration diagram of a terminal relay communication service based on the 5G NR technology.

FIG. 3 is a conceptual diagram of a SL-SCH MAC subheader structure of a comparative example.

FIG. 4 is an exemplary diagram illustrating an identifier conflict problem of a relay terminal related to different service zones in a relay communication service of a comparative example.

FIG. 5 is a sequence chart for describing an example of a case in which an indirect identifier conflict phenomenon occurs in a discovery process.

FIG. 6 is a sequence chart for describing an example of case in which an indirect identifier conflict phenomenon occurring in an access process.

FIG. 7 is a sequence chart for describing an example of a case in which an indirect identifier conflict phenomenon occurs in an identifier update process.

FIG. 8 is a sequence chart for describing a method for handling an identifier conflict in a relay communication access service through wireless direct communication according to an exemplary embodiment of the present disclosure.

FIG. 9 is an exemplary diagram of a message format including information on preliminary identifier(s) to cope with an identifier conflict, which may be employed in the method of FIG. 8.

FIG. 10 is a schematic block diagram of an identifier conflict handling apparatus for handling an identifier conflict in a relay communication access service through wireless direct communication according to another exemplary embodiment of the present disclosure.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, ‘at least one of A and B’ may mean ‘at least one of A or B’ or ‘at least one of combinations of one or more of A and B’. Also, in exemplary embodiments of the present disclosure, ‘one or more of A and B’ may mean ‘one or more of A or B’ or ‘one or more of combinations of one or more of A and B’.

In exemplary embodiments of the present disclosure, ‘(re)transmission’ may mean ‘transmission’, ‘retransmission’, or ‘transmission and retransmission’, ‘(re)configuration’ may mean ‘configuration’, ‘reconfiguration’, or ‘configuration and reconfiguration’, ‘(re)connection’ may mean ‘connection’, ‘reconnection’, or ‘connection and reconnection’, and ‘(re-)access’ may mean ‘access’, ‘re-access’, or ‘access and re-access’.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

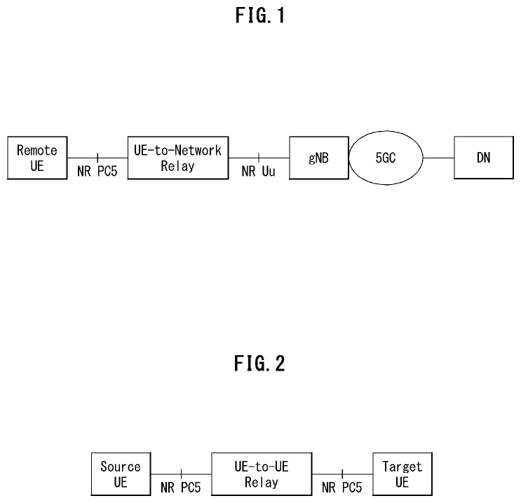

Before describing exemplary embodiments of the present disclosure in detail, the necessity of the present disclosure will be first described with reference to the comparative examples of FIGS. 1 to 7.

The 3rd Generation Partnership Project (3GPP) is conducting researches on the next-generation (e.g., fifth generation (5G)) radio access technology to satisfy user requirements after the spread of Long-Term Evolution (LTE) technology, and the technology related to the researches is referred to as ‘5G new radio (NR)’. The 5G NR technology provides a wireless access through high-frequency bands from several GHz to several tens of GHz, which is one of the major characteristics that differentiates it from the existing communication schemes. Due to the characteristics of the high frequency band used in the 5G NR, a connection interruption and a high transmission loss may occur due to obstacles on a propagation path in a wireless link, and instantaneous disconnection may occur due to a sudden environmental change in a wireless quality.

Another characteristic of the NR technology is that a service is provided by applying techniques such as beamforming as a method to overcome the high path loss that occurs when providing a communication service through such a very high frequency band. The beamforming is a technology that generates a radio wave directivity that emits or receives signals only in a desired specific direction through a densely directional radio beam using multiple or array antennas. Such the beamforming, as one of the main features of a multi-antenna technology, also enables spatial filtering function that increases directivity only in a desired specific direction, and spatial multiplexing in which multiple signals are transmitted as being multiplexed together on a spatial channel.

The most important consideration in providing a wireless communication service to a moving object such as a vehicle by applying the 5G NR technology based on a millimeter wave (mmWave) is that when a terminal moves in a direction of a road in a service environment such as a road, a problem may occur in which radio wave propagation is interrupted by obstacles such as road signs or street trees or other moving objects on a radio path between a base station and the terminal, resulting in a communication interruption.

Accordingly, when a failure occurs between the base station and the terminal, a method in which another adjacent relay terminal with good connectivity with the base station is utilized to provide a relay access service to the failed terminal (i.e., remote terminal) through the communication technology according to the NR technical specifications is being studied. Through this, not only the above-mentioned problem can be solved, but also a reliable and stable communication service can be provided.

Representatively, a relay technology using a sidelink technology among the NR technologies is being studied as a relay access technology. The sidelink technology is being standardized as a technology for supporting Vehicle-to-Everything services enabling inter-vehicle communications. Currently, in the 3GPP, research and standardization work on network relay communications utilizing direct communication between adjacent terminals within a certain zone is actively being conducted in order to improve the connectivity and service quality of the 5G communication network. The relay communication may be defined as having the following characteristics.
Relay structure based on NR-based PC5 interface
Network structure supporting Proximity Services (ProSe)
QoS-related specifications are applied based on the contents applied to PC5

Meanwhile, in the 3GPP NR, the relay service is classified into three types of scenarios. The first is an in-coverage scenario in which the network directly controls resources used for relay communication. This scenario refers to a scheme in which the network directly allocates specific resources to be used for the relay communication to a terminal performing the relay communication, or allocates a resource pool in which a terminal performing the relay communication function can select and use a resource for the relay communication. Such the in-coverage scenario has a feature of avoiding interference between wireless communications and optimizing direct communications.

The second is an out-of-coverage scenario, which corresponds to a case in which it is impossible for the network to directly control the relay communication or the network does not perform the control function. In this scenario, a relay terminal performs a relay communication function by using preconfigured relay communication-related resources and configured parameters.

Finally, a partial coverage scenario may exist. This scenario is a special case of the relay communication service scenario. A relay terminal corresponding to an in-coverage terminal may be allocated resources from the network, but a remote terminal corresponding to an out-of-coverage terminal may utilize preconfigured relay communication resources and configuration. In this scenario, careful coordination between the network-controlled relay resources and the preconfigured relay resources is required for efficient communications and avoiding interference between cell edge terminals and out-of-coverage terminals.

In addition, the aforementioned relay communication may be largely classified into a network relay service and a terminal relay service according to a service configuration. The network relay service is a service type in which a remote terminal is guaranteed connectivity with a network through a relay terminal. Also, the terminal relay service is a service type in which a remote terminal is guaranteed connectivity with other remote terminals through a relay terminal.

In such the relay communication scenario, it is assumed that an NR Uu interface is applied to a Uu connection between the relay terminal and the base station, and an NR sidelink is applied to a PC5 connection between the remote terminal and the relay terminal. Here, the Uu refers to a radio interface between a user equipment (UE) and a radio access network (RAN), and the NR Uu interface refers to a radio interface or radio link between a UE and an NR base station (i.e., gNB).

FIG. 1 is a conceptual configuration diagram of a network relay communication service based on the 5G NR technology.

As shown in FIG. 1, in a network relay communication service, a remote user terminal (i.e., remote UE) (hereinafter, simply referred to as a remote terminal) and a UE-to-Network relay are connected through an NR PC5 interface, the UE-to-Network relay and an NR base station (i.e., gNB) are connected through an NR Uu interface, and a 5G core network (i.e., 5GC) connected with the NR base station is connected to a data network DN.

FIG. 2 is a conceptual configuration diagram of a terminal relay communication service based on the 5G NR technology.

As shown in FIG. 2, in a terminal relay communication service, a source terminal (i.e., source UE) and a UE-to-UE relay are connected through an NR PC5 interface, the UE-to-UE relay and a target terminal (i.e., target UE) are connected through an NR PC5 interface.

In a relay communication function using direct communications between terminals based on the above-described network relay service or terminal relay service, a procedure for providing a network connection service may be as follows.

1. Through a registration process, each terminal registers relay communication-related information in a network.

2. Through an authentication process, each terminal acquires authority and parameters related to relay communication.

3. Each terminal performs a discovery process for relay communication.

4. A remote terminal desiring to receive a relay communication service performs a selection process for an adjacent relay terminal.

5. The remote terminal desiring to receive a relay communication service performs a process for access to the selected relay terminal.

6. A relay terminal requested for relay communication performs necessary network-related processing.

7. The relay terminal performs connection establishment to perform the relay communication.

8. The relay terminal initiates the relay communication service for the remote terminal.

Meanwhile, in the aforementioned network connection service, if a control process on the remote terminal desiring to receive the relay communication service according to a normal base station processing is not performed due to an access failure or a situation of the base station, the initial registration and authentication process through the network may be omitted and the corresponding registration and authentication process may be performed using default service parameters preconfigured in the terminal. After the connection processing is completed, in a step of performing the network-related processing, the relay communication-related information may be updated in relation to the registration and authentication processed by the default service parameters by performing the registration and authentication through the network again.

In general, main identification information used for identification of each terminal in relation to the network relay service may include a relay service code, a terminal identifier (i.e., UE Identification (UE ID)), user information, application layer ID, and the like.

The relay service code is an identification value used to distinguish connection service information provided by the network relay service. The terminal ID is an identifier of a connection layer, which is used for direct communications and is a value associated with the relay service code. The terminal ID should be applied uniquely and identifiably to each terminal, which corresponds to the relay service code used for the relay service. The user information is identification information used in the discovery process, and is a value indicating a user information ID for a relay communication service provider or receiver. In addition, the application layer ID is an identifier used to identify the terminal in an application layer.

For information transfer through direct communication, each terminal has a unique connection layer identifier including a Layer 2 (L2) identifier. Through this, a terminal performing direct communication may identify a sender and/or receiver of a packet transmitted through the PC5 interface.

That is, a frame transmitted through direct communication includes L2 identifiers of the sender and the receiver, and each frame is distinguished based on a combination thereof The terminal maintains its L2 identifier to be unique in a direct communication environment within a relay service zone. If an identifier used by an adjacent terminal and its own identifier are assigned overlappingly, an identifier conflict problem may occur, and this problem should be dealt with by assigning a new source L2 ID.

A source L2 ID is always self-assigned by the terminal initiating transmission of a L2 frame. The L2 ID of a target terminal corresponding thereto may be identified by an application layer ID, and it may be obtained in a process of configuring the PC5 link or from information of previously-performed communication for the same application layer ID or contents of an application layer service announcement. By managing a correspondence relationship between the application layer ID and the source L2 ID, the terminal may change it L2 ID without interruption of the application service when necessary.

After performing the registration and authentication process, the terminal desiring to participate in a relay communication service should first perform a discover process to acquire information on whether other adjacent terminal(s) exists nearby and relay communication-related information of the adjacent terminal(s). In order to perform such the discovery process, the terminal should first acquire application layer information. The corresponding information may be delivered from an application server, or preconfigured parameters may be utilized as the corresponding information.

The discovery process may be mainly performed in one of two schemes. The first scheme is a scheme in which a relay terminal desiring to provide a relay communication service provides information related to the relay communication service to adjacent terminals, and a remote terminal receiving the information accesses the relay terminal based on the received information when it requires the relay communication service. The second scheme is a scheme in which a remote terminal desiring to receive a relay communication service provides information related to a relay communication service it requires to adjacent relay terminals, and a relay terminal receiving the information transmits information on whether the required relay communication can be provided to the remote terminal in response to the request. In such the discovery process, each of the terminals may determine a L2 ID used for connection establishment, and the L2 IDs may be used to identify corresponding terminals in the relay communication.

The remote terminal, which has identified the existence of nearby relay terminal(s) and obtained the relevant information through the discovery process, may perform a selection process of determining a relay terminal to perform a relay communication service required by the remote terminal based on the information.

The remote terminal that has undergone the discovery and selection process may prepare for a relay service by performing an access process and a network processing for establishing a connection with the selected relay terminal.

For access, the remote terminal may initiate a connection procedure for the relay service by transmitting a direct communication request message including a terminal ID of the remote terminal, user information related to relay communication, and relay communication service related information to the relay terminal through the PC5 interface. In this case, the source terminal (i.e., remote terminal) and the target terminal (i.e., relay terminal) are distinguished using the respective L2 IDs. For this direct communication request, the relay terminal monitoring a remote access request may verify whether a destination address of the received request message matches its own L2 ID, and if the verification result is successful, the relay terminal may regard the request as a normal request and notify that the request has been approved by returning an acknowledgment message corresponding to the message to the remote terminal.

In message transmission related to the relay communication between terminals as described above, a terminal transmitting a message may specify a destination of the message by providing an identifier of the terminal and an identifier of a target terminal or group that is a target of the transmitted message in the message. In this case, a connection layer identifier of the terminal or group used may be composed of 24 bits.

A format of a protocol data unit (PDU) used for message transmission may conform to that of a general medium access control (MAC) PDU, and may include a sidelink-shared channel (SL-SCH) subheader for relay communication. The SL-SCH subheader may include a source identifier (source, SRC) corresponding to a source terminal transmitting a message, a destination identifier (destination, DST or DEST) of a target terminal that is a target of the message, and a version number (version, V).

The lower 8 bits of the source identifier SRC may be used as control channel information for filtering data packets in a physical layer. The remaining upper 16 bits of the source identifier may be used for identifying the source terminal in a MAC layer. On the other hand, the lower 16 bits of the destination identifier may be used as control channel information for filtering data packets in the physical layer, and the remaining upper 8 bits may be used for identifying the target terminal. Using these identifiers, each terminal may check suitability of data of the message received in the MAC layer. If the identifier of the received message does not coincide with its own identifier, the terminal may delete the corresponding message.

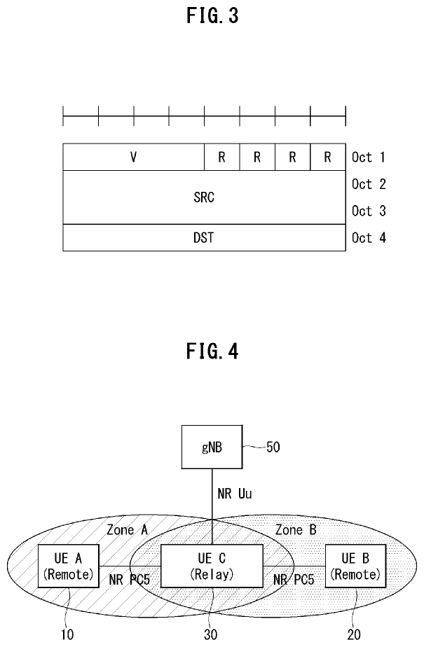

FIG. 3 is a conceptual diagram of a SL-SCH MAC subheader structure of a comparative example.

As shown in FIG. 3, a SL-SCH subheader of the comparative example has a fixed size and consists of 7 header fields of V/R/R/R/R/SRC/DST. The five header fields V/R/R/R/R may be included in the first octet (i.e., Oct 1) of the subheader, the field SRC may be included in the second and third octets (i.e., Oct 2 and Oct3), and the field DST may be included in the fourth octet (i.e., Oct 4).

Meanwhile, a PDU of the MAC layer, which is used for data transmission of the relay service, may be composed of one SL-SCH subheader and one or more MAC subPDUs. Each MAC subPDU may be configured in one of the following types, and the length of a MAC service data unit (SDU) may be variable.
A MAC subheader only (including padding);
A MAC subheader and a MAC SDU;
A MAC subheader and a MAC CE;
A MAC subheader and padding

Here, the MAC SDU may mean a MAC layer service data unit (MSDU), and a MAC CE may mean a MAC layer control element. The MAC subheader without padding may consist of four header fields R/F/LCID/L. The MAC CE and a MAC subheader with padding may consist of two header fields R/LCID.

That is, a SL MAC subPDU including a MAC subSDU may be disposed after a SL-SCH subheader and before a MAC subPDU having a MAC CE and a MAC subPDU including padding of a MAC PDU. The SL MAC subPDU including the MAC CE may be disposed after all MAC subPDUs including the MAC SDU and before the MAC subPDU including padding of the MAC PDU. The size of the padding may be 0.

In the MAC subheader, the field L may indicate the length in bytes of the MAC SDU, and the field LCID (i.e., logical Channel ID) may identify a logical channel instance or may identify a type of the MAC CE within a range of a pair of a source L2 ID and a destination L2 ID of the corresponding MAC SDU or padding.

Meanwhile, in a service data adaptation protocol (SDAP) layer involved in data transmission of the relay service, an SDAP entity may be configured based on the L2 ID and a declared type of the target terminal. When connections are made with a plurality of terminals at the same time, a correspondence between a specific entity and each specific terminal may be identified based thereon.

Therefore, when an identifier conflict phenomenon for the target terminal occurs, a problem in which the target terminal cannot be identified on sidelink protocol layers in a process of processing uplink traffic and downlink traffic.

The relay communication service currently being researched and developed makes it a basic requirement of the relay service that each terminal is locally and specifically identified. That is, in order to provide the relay service, it is assumed that there is no conflict problem of connection layer identifiers between terminals participating in the relay service within a predetermined service zone in which the terminals exist. In addition, it is assumed that, when a phenomenon of identifier conflict between the terminals occurs, the problem of duplicate connection layer identifiers is solved at a terminal-level through a process such as reassignment of the identifier.

The identifier conflict of the relay terminal may be classified into a direct conflict and an indirect conflict. The direct conflict is a case in which identifiers between adjacent terminals overlap, and this can be resolved through processing such as changing the identifier of the terminal by the terminal detecting the conflict. In addition, the indirect conflict is a case in which identifiers between terminals belonging to different relay service zones overlap. In principle, the identifier of the terminal should be unique within a relay service zone, and may be configured independently of identifiers of other service zones. However, when a terminal related to a relay service in one service zone is simultaneously related to a relay service in another service zone, an identifier conflict problem between two service zones may cause a big problem in the relay service.

FIG. 4 is an exemplary diagram illustrating an identifier conflict problem of a relay terminal related to different service zones in a relay communication service of a comparative example.

Referring to FIG. 4, each of two remote terminals (i.e., remote UE A and UE B) may be provided with a network relay service or a terminal relay service through a relay or a relay terminal (i.e., UE C). In this case, the relay terminal C may be connected to the remote terminal A through an NR PC5 interface in a zone A, and may be connected to the remote terminal B through an NR PC5 interface in a zone B.

The remote terminal A may be located within a range capable of communicating with the relay terminal C while belonging to the zone A, and the remote terminal B may be located with a range of capable of communicating with the relay terminal C while belonging to the zone B. The remote terminals A and B may be located outside a range where direct communication therebetween is possible.

As described above, each terminal may configure its own identifier uniquely within its zone. For example, the relay terminal C may configure its identifier as ID-1, and each of the remote terminal A and remote terminal B may configure its identifier as ID-2.

Each of the remote terminals A and B may be provided with a network relay service via the relay terminal C or may be provided with a terminal relay service for a remote terminal belonging to another zone. Each of the remote terminal A and the remote terminal B may request the relay terminal C to transmit a frame to a network or another relay terminal by transmitting the frame in which its own addresses is configured as a source address to the relay terminal C.

The network or another terminal may request the relay terminal C to transmit to itself a frame in which the address of the remote terminal A or the remote terminal B is configured as a destination address. In this case, the relay terminal C may not successfully relay the frame because an error occurs in identifying a source or target terminal for the corresponding frame due to the identifier conflict due to the same identifier (i.e., ID-2).

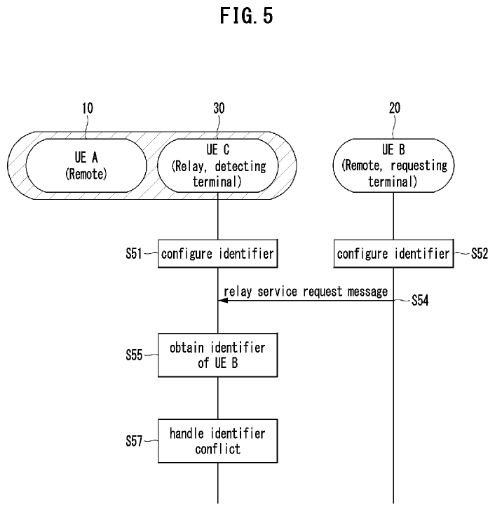

As shown in FIGS. 5 to 7, the processing on the identifier conflict that occurs in the process of the relay service may be classified into three cases.

FIG. 5 is a sequence chart for describing an example of a case in which an indirect identifier conflict phenomenon occurs in a discovery process.

As shown in FIG. 5, each of the terminals A, B, and C (i.e., UE A, UE B, and UE C) may uniquely configure its own identifier within its zone (S51 and S52). The remote terminal A and the relay terminal C belonging to the same service zone may be in service by configuring a relay service. In addition, the remote terminal B may enter a communication range of the relay terminal C to start a relay service.

In this case, the remote terminal A and the remote terminal B may not have a direct connection. The terminal B may provide its relay service request to an adjacent relay terminal (i.e., UE C) through a discovery process (S54). The terminal C may acquire the relay service request of the terminal B including the identifier of the terminal B through a discovery process. That is, based on the detected request message, the relay terminal C may obtain the identifier of the terminal B (S55), and identify that the identifier of the terminal B overlaps with the terminal A currently in the relay service. If the identifier conflict occurs, the relay terminal C may handle the identifier conflict according to a configured scheme (S57). For example, the handling on the identifier conflict may be a reassignment request for the duplicate identifier.

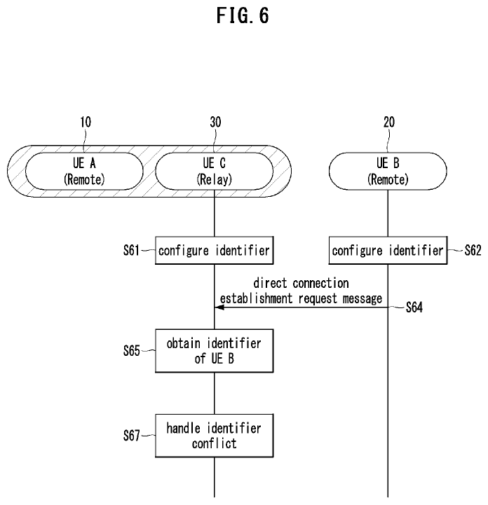

FIG. 6 is a sequence chart for describing an example of case in which an indirect identifier conflict phenomenon occurring in an access process.

As shown in FIG. 6, each of the terminals A, B, and C (i.e., UE A, UE B, and UE C) may uniquely set its own identifier within its zone (S61 and S62). The remote terminal A and the relay terminal C belonging to the same service zone may be in service by configuring a relay service. In addition, the remote terminal B may enter a communication range of the relay terminal C to start a relay service.

In this case, the remote terminal A and the remote terminal B 20 may not have a direct connection. The terminal B may request direct connection establishment by transmitting a direct connection establishment request message to the relay terminal C according to a configuration (S64).

The direct connection establishment request message may include information related to a relay service required by the remote terminal B. That is, based on the identifier of the terminal B included in the direct connection establishment request message, the relay terminal C may identify that the identifier of the terminal B overlaps the identifier of the terminal A already in the relay service (S65). If the identifier conflict occurs, the relay terminal C may perform handling on the identifier conflict according to a preconfigured scheme. For example, the handling on the identifier conflict may be a rejection to the direct connection establishment request. The rejection to the direct connection establishment request may indicate the identifier conflict as a cause of the rejection.

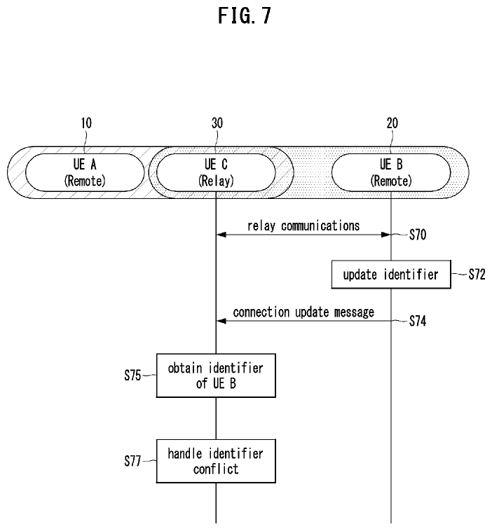

FIG. 7 is a sequence chart for describing an example of a case in which an indirect identifier conflict phenomenon occurs in an identifier update process.

As shown in FIG. 7, each of the terminals A, B, and C (i.e., UE A, UE B, and UE C) may uniquely configure its own identifier within its zone. The remote terminal A and the relay terminal C belonging to the same service zone may be in service by configuring a relay service. In addition, the relay terminal C and the remote terminal B belonging to another same service zone may configure another relay service to be in service (S70).

In this case, the remote terminal A and the remote terminal B may not have a direct connection. The remote terminal B may update its identifier according to a configuration when necessary (S72). When updating the identifier, the remote terminal B may transmit an updated identifier to the relay terminal C through a connection update message having a form such as an identifier update message (S74).

Based on the connection update message, the relay terminal C may obtain the updated identifier of the terminal B (S75), and identify that the updated (i.e., to-be-updated) identifier of the terminal B overlaps the terminal A currently in the relay service. If the identifier conflict occurs, the relay terminal C may perform handling on the identifier conflict according to a preconfigured scheme (S77). For example, the handling on the identifier conflict may be a rejection to the connection update request. The rejection to the connection update may indicate the identifier conflict as a cause of the rejection.

As described above, when a relay service request from another terminal is rejected due to the identifier duplication, the terminal receiving the request may specify the reason for rejection due to the identifier duplication in a rejection message for the request.

Table 1 below shows an example of configuration of a direct communication rejection message for a direct communication establishment request in a proximity communication specification of the 5G NR.

TABLE 1

| Information Element | Type/Reference | Presence | Format | Length |
|---|---|---|---|---|
| DIRECT_COMMUNICATION_REJECT | PC5-SP Message Type | M | V | 1 |
| message identity | | | | |
| Sequence Number | Sequence Number | M | V | 2 |
| PC5 Signalling Cause Value | PC5 Signalling Cause Value | M | V | 1 |

The direct communication rejection message (i.e., DIRECT_COMMUNICATION_REJECT) is transmitted from a target terminal to a requesting terminal to indicate that the direct communication establishment request is rejected. In this message, a direct communication rejection message identity (ID) indicates that the message is one of the message types used in the protocol for PC5 signaling and is a rejection message for the direct communication establishment request. A sequence number is used to uniquely identify the transmitted PC5 signaling message, and is incremented within a field value range for each signaling message. In addition, a PC5 signaling cause value is used to indicate an error cause value used in the protocol for PC5 signaling.

Table 2 below shows the cause values used in the direct communication rejection message. In Table 2, 5-8 bits of the 8-bit cause value field are reserved values.

TABLE 2

| Bits | | | | |
|---|---|---|---|---|
| 4 | 3 | 2 | 1 | Type |
| 0 | 0 | 0 | 1 | Direct communication to target UE not allowed |
| 0 | 0 | 1 | 0 | Authentication failure |
| 0 | 0 | 1 | 1 | Conflict of Layer 2 ID for unicast communication is |
| | | | | detected |
| 0 | 0 | 0 | 0 | Lack of resources for proposed link |
| 0 | 1 | 0 | 1 | IP version mismatch |
| 0 | 1 | 1 | 0 | Link setup failure due to other errors |
| 0 | 1 | 1 | 1 | UE security capabilities mismatch |
| 1 | 0 | 0 | 0 | Unspecified error |
| 1 | 0 | 0 | 1 | Authentication synchronisation error |
| 1 | 0 | 1 | 0 | Non-responsive peer during security mode procedure |

Table 2 shows the first to tenth cause values. For example, the first cause value may indicate that direct communication to the target terminal is not permitted, the second cause value may indicate an authentication failure, and the third cause value may indicate a L2 ID conflict.

As described above, it is a basic prerequisite for the relay service to uniquely maintain identifiers of terminals related to the relay service within the relay service zone.

If an identifier conflict problem for terminals occurs, it becomes impossible to identify the terminals participating in the relay communication service, so that it is impossible to configure an accurate path in transmission between the terminals.

In addition, in the case of a relay service including a terminal belonging commonly to different service zones, detecting and handling an identifier conflict phenomenon of the terminal belonging to different zones is essential for terminal identification and path configuration. To this end, each terminal should check and process whether the identifier conflict occurs in the discovery process, connection establishment, and maintenance process.

In addition, in order to handle the identifier conflict, the terminal may perform a process of reassigning an ID to itself or another terminal as needed. If the identifier conflict is detected in the process of access and update processing, the terminal may reject a relay service-related request of the corresponding terminal due to the identifier conflict. In this case, the terminal receiving the request rejection information may update the corresponding duplicate identifier and, if necessary, perform a reprocessing process. The identifier conflict handling such as request, rejection, and reprocessing may act as a delay factor in the process of providing relay services.

Therefore, it can be said that detection of an identifier conflict phenomenon for a terminal related to a relay service and an effective method for handling it are one of the important considerations for a reliable relay service.

Moreover, in the case of ultra-high frequency communication service using a millimeter wave (mmWave) band, the change in connection quality is extreme due to factors such as changes in the wireless channel-related environment within the service zone, the mobility of the terminal, and changes in the communication environment caused by surrounding moving objects. Therefore, in the case of a poor connectivity between base stations under the mmWave communication service environment in which such rapid changes occur, the possibility of utilizing relay communication serviced for a relatively short period of time to ensure stable network connectivity is very high.

In the case of direct communications and relay communications on a Moving Network (MN) service that mainly targets high-speed moving objects such as vehicles, participating vehicles may frequently leave a service zone, or new vehicles may frequently appear in the service zone. Therefore, processes of configuring, changing, and terminating relay communication paths may occur quickly and frequently for a certain period of time within the relay service zone. In such a situation, if the process of handling the terminal's identifier conflict problem related to the relay service is complicated or there is a delay in the processing, the service reliability for the terminal participating in the service may be greatly damaged and the service quality may deteriorate, and inefficient identifier conflict handling scheme may act as a factor that degrades the overall relay system performance and deteriorates service reliability.

Accordingly, exemplary embodiments of the present disclosure provides a method for maintaining service quality on the MN service and securing service reliability for the entire relay system performance through an efficient identifier conflict handling technique.

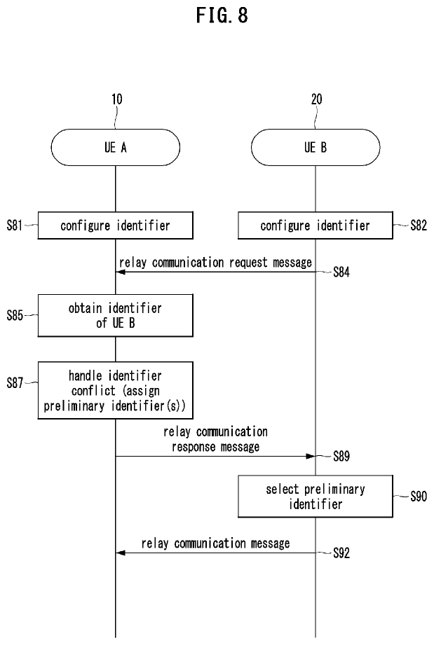

FIG. 8 is a sequence chart for describing a method for handling an identifier conflict in a relay communication access service through wireless direct communication according to an exemplary embodiment of the present disclosure.

Referring to FIG. 8, the terminal A (i.e., UE A) 10 and a terminal B (i.e., UE B) 20 may uniquely configure their own identifiers within a zone (S81 and S82). The terminal A may function as a relay terminal. The relay terminal A may belong to another service zone, configure a relay service with another terminal, and be in the service. In this case, the remote terminal B may not have a direct connection with another remote terminal serviced by the relay terminal A.

If the remote terminal B has not established a relay service connection with the relay terminal A, the remote terminal B may transmit a direct access request message (i.e., relay communication request message) to the relay terminal A according to a configuration (S84). The direct access request message, which is a relay communication request message, may include information related to a relay service required by the remote terminal B.

Then, the relay terminal A may obtain an identifier of the remote terminal B through the direct access request message (S85).

Then, the relay terminal A may identify that the identifier of the remote terminal B overlaps with that of another relay terminal located in a service zone different from the zone of the remote terminal B and being serviced by itself. If the identifier conflict occurs, the relay terminal A may assign one or more preliminary identifiers to the remote terminal B according to a preconfigured scheme (S87).

Then, the relay terminal A may perform handling on the identifier conflict according to a preconfigured scheme. The handling on the identifier conflict may be a rejection to the direct access request. The rejection to the direct access request may be informed to the remote terminal B through a relay communication response message indicating the identifier conflict as a cause of the rejection (S89). In this case, the direct access request rejection information may include information on the preliminary identifier(s) assigned by the remote terminal A to the remote terminal B.

Then, the remote terminal B may process the received response message or the message for rejecting the direct access request. If the message for rejecting the direct access request includes the preliminary identifier(s) assigned by the relay terminal A to the remote terminal B, the remote terminal B may determine whether to apply the preliminary identifier(s). In the case of applying the preliminary identifier(s), the remote terminal B may select one of the preliminary identifier(s) (S90).

Thereafter, the remote terminal B may apply the selected preliminary identifier to the relay service with the relay terminal A, and transmit a relay communication message to the relay terminal A by using the selected preliminary identifier (S92).

After receiving the relay communication message to which the selected preliminary identifier is applied, the relay terminal A may identify that the identifier of the received message matches the preliminary identifier assigned in the step S87 by the relay terminal.

In addition, when it is identified that the identifier of the received message matches the preliminary identifier assigned by the relay terminal A, the relay terminal A may release reservation for the remaining preliminary identifier(s) excluding the selected preliminary identifier.

Meanwhile, the remote terminal B may be in a process of performing a relay service by establishing a relay service connection with the relay terminal A. When necessary, the remote terminal B may update its identifier according to a configuration. When desiring to update the identifier, the remote terminal B may transmit an updated (i.e., to-be-updated) identifier to the relay terminal A through a connection update message in the same form as the identifier update message.

Based on the connection update message, the relay terminal A may obtain the to-be-updated identifier of the remote terminal B.

The relay terminal A may check whether the to-be-updated identifier of the remote terminal B overlaps with an identifier of another remote terminal that is located in a service zone different from the zone of the remote terminal B and is being provided by the relay terminal A with a relay service.

If an identifier conflict occurs, the relay terminal A may assign one or more preliminary identifiers to the remote terminal B according to a preconfigured scheme.

In addition, the relay terminal A may perform handling on the identifier conflict according to a preconfigured scheme including assignment of a preliminary identifier. The handling on the identifier conflict may be a rejection to the connection update request. The rejection to the connection update request may indicate the identifier conflict as a cause of the rejection. In this case, information on the rejection to the connection update request may include information on the preliminary identifier(s) assigned by the relay terminal A to the remote terminal B.

The remote terminal B may process the received message for rejecting the connection update request. If the message includes the preliminary identifier(s) assigned by the relay terminal A to the remote terminal B, the remote terminal B may determine whether to apply the preliminary identifier(s). If the preliminary identifier(s) is utilized, the remote terminal B may select one of the preliminary identifier(s).

Thereafter, the remote terminal B may apply the selected preliminary identifier to the relay service with the relay terminal A, and transmit a relay communication message to the relay terminal A by using the selected preliminary identifier.

Upon receiving the relay communication message, the relay terminal A may identify that the identifier of the received message matches the preliminary identifier assigned by itself. In addition, when it is identified that the identifier of the received message matches the preliminary identifier assigned by the relay terminal A, the relay terminal A may release reservation for the remaining preliminary identifier(s) related to the remote terminal B excluding the selected preliminary identifier.

In the present exemplary embodiment, in order to efficiently solve the identifier conflict problem of the terminal that has requested a relay communication-related service from the counterpart terminal by configuring its unique identifier, preliminary identifier(s) generated to cope with the identifier conflict problem may be configured in a specific data format. In this case, the identifier of the terminal, as a connection layer identifier, may be composed of a L2 identifier, which is an upper layer identifier, and a physical layer identifier, which is a lower layer identifier.

When a relay terminal, which has obtained an identifier of a remote terminal through a relay service request, determines that the identifier of the remote terminal overlaps with an identifier of another adjacent remote terminal, the relay terminal may assign preliminary identifier(s) to respond to the terminal requesting the relay service. Depending on a service configuration, the relay terminal may respond with a plurality of preliminary identifiers. The preliminary identifier(s) may be determined by checking whether they overlap with the identifier of the terminal requesting the relay service. A result of determining whether the identifier for direct wireless communication is overlapped may be transmitted to the requesting terminal according to a service configuration.

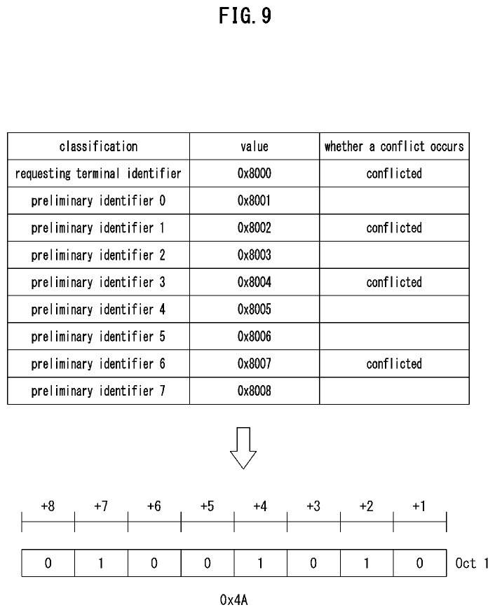

FIG. 9 is an exemplary diagram of a message format including information on preliminary identifier(s) to cope with an identifier conflict which may be employed in the method of FIG. 8.

Referring to FIG. 9, a message format including information on preliminary identifier(s) is for handling an identifier conflict in wireless direct communication, and may be configured to deliver information on the preliminary identifier(s) by using an additional field.

For example, when an upper layer identifier of a terminal (i.e., requesting terminal) requesting a relay service is 0x8000, a preliminary identifier range may be 8. When a target terminal (i.e., relay terminal) receiving the relay service request identifies that the identifier of the requesting terminal overlaps with an identifier used for a relay service with another terminal existing within a service zone of the relay terminal, the relay terminal may transmit a response message to the requesting terminal in a form of a rejection to the request.

In this case, the target (i.e., relay) terminal may determine whether the identifier of the requesting terminal overlaps with an identifier of another terminal within a predetermined conflict checking range. For example, if an upper layer identifier of the requesting terminal is 0x8000 and the conflict checking range is 8, the relay terminal may check whether another terminal in a relay service zone in which the relay terminal is participating has preempted an identifier from 0x8001 to 0x8008.

If a case where another terminal is using the corresponding identifier is expressed as ‘1’ and a case where another terminal is not using the corresponding identifier is expressed as ‘0’, 8 bits may be used for 8 identifiers. That is, a status of the preliminary identifiers illustrated in FIG. 9 may be expressed as ‘0x4A’. The relay terminal receiving the relay service request may transmit a response message in response to the relay service request by attaching the status of the preliminary identifiers. The terminal that has transmitted the status of the preliminary identifiers may expect to receive an identifier within the range of the preliminary identifiers for a certain period of time.

The requesting terminal receiving the status of the preliminary identifiers may exclude conflicted identifiers within the preliminary identifier range (i.e., 0x8001 to 0x8008). When there are a plurality of available preliminary identifiers, the requesting terminal may select one preliminary identifier according to a preconfigured scheme such as a scheme of selecting the minimum value or a scheme of selecting the maximum value, and configure the selected preliminary identifier as its own identifier.

The requesting terminal that has configured one of the preliminary identifiers as its own identifier may transmit a relay communication message related to the relay service to the relay terminal using the selected preliminary identifier, so that the relay service can be performed without a reconfiguration process.

Upon receiving the relay communication message based on the preliminary identifier selected by the requesting terminal, the relay terminal may identify the received preliminary identifier and release reservations for other configured preliminary identifiers. For example, if the requesting terminal with the upper layer identifier set to 0x8000 receives a response of the identifier conflict from the relay terminal and receives the status of preliminary identifiers as ‘0x4A’, the requesting terminal may configure 0x8001 as the upper layer identifier to continue the relay service.

When the relay communication message using 0x8001 is received within a configured period, the relay terminal having responded with the preliminary identifiers set to 0x8001-0x8008 may determine that the requesting terminal using the identifier 0x8000 received its response message and updated the identifier 0x8000 to 0x80001 by utilizing the attached information on the preliminary identifiers and continue the relay service.

In addition, the relay terminal may release the reservation for the remaining preliminary identifiers excluding 0x8001 among the configured preliminary identifiers 0x8001 to 0x8008. Table 3 below shows an example of delivering information on the preliminary identifiers for coping with identifier conflict by using a response code included in a response message for a relay service request.

As shown in Table 3, when the upper layer identifier of the terminal requesting a relay service is 0x8000, a preliminary identifier range (i.e., conflict checking range) may be 4. When a target terminal receiving the relay service request identifies that the identifier of the requesting terminal overlaps with an identifier used for a relay service with another terminal existing within a service zone of the relay terminal, the relay terminal may transmit a response message to the requesting terminal in a form of a rejection to the request. In this case, the target terminal may determine whether the identifier of the requesting terminal overlaps with an identifier of another terminal within a predetermined conflict checking range.

For example, if the upper layer identifier of the requesting terminal is 0x8000 and the conflict checking range is 4, the relay terminal may check whether another terminal in a relay service zone in which the relay terminal is participating has preempted an identifier from 0x8001 to 0x8004.

If a case where another terminal is using a corresponding identifier is expressed as ‘1’ and a case where another terminal is not using the corresponding identifier is expressed as ‘0’, 4 bits may be used for 4 identifiers. That is, a status of the preliminary identifiers may be expressed as ‘0xA’. The terminal receiving the relay service request may express the corresponding information according to a configured scheme in a reserved part of a reason field of a response message to the request. The format of the reason field of the response message according to the present exemplary embodiment may be configured as follows. In the reason field format, a value of the reason field indicating the status for the preliminary identifiers may be ‘0xFA’.

TABLE 3

| Bits | | | | | | | | |
|---|---|---|---|---|---|---|---|---|
| 8 | 7 | 6 | 5 | 4 | 3 | 2 | 1 | Type |
| 1 | 1 | 1 | 1 | x | x | x | x | Preliminary UE ID Information for |
| | | | | | | | | Conflict Handing with conflict flag |
| | | | | | | | | x |

The target terminal that has transmitted the status of the preliminary identifiers using the reason field of the response message may expect to receive an identifier within the preliminary identifier range for a certain period of time.

The requesting terminal receiving the status of the preliminary identifiers may exclude conflicted identifiers within the reserve identifier range. When there are a plurality of available preliminary identifiers, the requesting terminal may select a preliminary identifier according to a preconfigured scheme such as a scheme of selecting the minimum value or a scheme of selecting the maximum value, and configure the selected preliminary identifier as its own identifier.

The requesting terminal that has configured one of the preliminary identifiers as its own identifier may transmit a relay communication message related to the relay service to the relay terminal using the selected preliminary identifier, so that the relay service can be performed without a reconfiguration process.

Upon receiving the relay communication message based on the preliminary identifier, the relay terminal may identify the received preliminary identifier and release reservations for other configured preliminary identifiers. For example, if the requesting terminal having the upper layer identifier set to 0x8000 receives a response indicating the identifier conflict from the target terminal and receives the status of preliminary identifiers as ‘0xA’, the requesting terminal may configure 0x8001 as the upper layer identifier to continue the relay service. When a relay communication message using 0x8001 is received within a configured period, the target terminal having responded with the preliminary identifiers set to 0x8001-0x8004 may determine that the requesting terminal using the identifier 0x8000 received its response message and updated the duplicate identifier 0x8000 to the preliminary identifier 0x80001 by utilizing the attached information on the preliminary identifiers and continue the relay service.

In addition, the target terminal may release the reservation for the remaining preliminary identifiers excluding 0x8001 among the configured preliminary identifiers 0x8001 to 0x8004.

Meanwhile, in the case of a terminal to which a relay communication service is applied using the preliminary identifier information providing scheme according to the exemplary embodiment of the present disclosure, an identifier to which the corresponding preliminary identifier related configuration is applied may be selected in a process of configuring the identifier of the terminal.

An example in which a terminal selects an identifier will be described assuming a relay communication system in which the preliminary identifier range is 4. A terminal desiring to use relay communication (i.e., remote terminal) may acquire information of an adjacent relay terminal within a service zone. When an identifier of the adjacent relay terminal is 0x8000, the remote terminal may exclude 0x8000, the identifier of the adjacent relay terminal, and 0x8001 to 0x8004, preliminary identifiers of the adjacent relay terminal, in a process of arbitrarily selecting its identifier. Through the above-described identifier selection, the remote terminal can reduce the possibility of not only a direct conflict with the identifier of the adjacent relay terminal, but also a conflict with the preliminary identifiers of the adjacent relay terminal that can be used in the process of handling the identifier conflict.

As described above, in the procedure according to the general identifier conflict handling scheme, when an identifier conflict occurs, a requesting terminal may identify a rejection due to the identifier conflict by receiving a rejection message for a relay communication-related request from a terminal identifying the identifier conflict. In this case, in order to resolve the identifier conflict, the requesting terminal that has received the corresponding rejection message may use relay communication information obtained within a local service zone where the corresponding terminal is located to arbitrarily reassign its own identifier that does not conflict with other terminals. Thereafter, the requesting terminal may re-perform the relay communication-related request process with respect to the target terminal by using the newly-assigned identifier. That is, as described above, the requesting terminal cannot acquire information about an indirect identifier conflict that occurs when the target terminal spans several service zones. Therefore, when the reselected identifier causes the indirect conflict, the requesting terminal should repeat the reconfiguration and re-request process. In this case, a service delay or disconnection may greatly impair connection reliability and lower service reliability.

On the other hand, when using the relay communication method to which the identifier handling technique according to the exemplary embodiments of the present disclosure, indirect identifier conflict can be efficiently processed even in a relay service situation through a relay terminal related to various service zones. In addition, information on the indirect identifier conflict that cannot be secured by acquiring local information may be provided. Through this, the identifier conflict problem can be solved more efficiently and reliably than the existing method that relies on an inefficient reprocessing process. That is, the possibility of repetitions of a simple request rejection, reconfiguration, and re-request process for dealing with the identifier conflict can be reduced. Accordingly, the possibility of service delay occurring in the reprocessing process is reduced, and deterioration of overall service quality and system performance can be prevented.

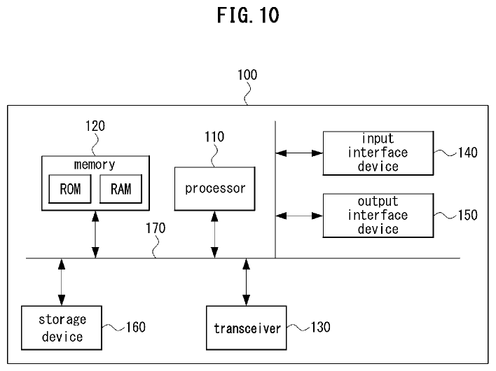

FIG. 10 is a schematic block diagram of an identifier conflict handling apparatus for handling an identifier conflict in a relay communication access service through wireless direct communication according to another exemplary embodiment of the present disclosure.

Referring to FIG. 10, the apparatus 100, as a type of apparatus such as a relay or a base station, may comprise at least one processor 110, a memory 120, and a transceiver 130 connected to the network for performing communications. Also, the apparatus 100 may further comprise an input interface device 140, an output interface device 150, a storage device 160, and the like. Each component included in the apparatus 100 may communicate with each other as connected through a bus 170.

However, each component included in the apparatus 100 may be connected to the processor 110 via an individual interface or a separate bus, rather than the common bus 270. For example, the processor 110 may be connected to at least one of the memory 120, the transceiver 130, the input interface device 140, the output interface device 150, and the storage device 160 via a dedicated interface.

The processor 110 may execute a program or instructions stored in at least one of the memory 120 and the storage device 160 to perform a process of handling an identifier conflict. The processor 110 may refer to a central processing unit (CPU), a graphics processing unit (GPU), or a dedicated processor on which methods in accordance with exemplary embodiments of the present disclosure are performed.

Each of the memory 120 and the storage device 160 may be constituted by at least one of a volatile storage medium and a non-volatile storage medium. For example, the memory 120 may comprise at least one of read-only memory (ROM) and random access memory (RAM).

The memory 120 or storage device 160 may store, in form or a program or instructions, a first module for processing reception and transmission of messages, a second module for obtaining an identifier of a terminal from a message, a third module or identifier assignment module for assigning preliminary identifiers for identifier conflict handling based on the identifier of the terminal, a fourth module or message generation module for generating a message including preliminary identifier information for the assigned preliminary identifiers, a fifth module or comparison module for identifying whether the assigned preliminary identifiers match the received preliminary identifier, a sixth module or release module for releasing reservations for the remaining preliminary identifiers excluding the matched preliminary identifier among the assigned preliminary identifiers.

The transceiver 130 may support at least one communication protocol and may be connected to a remote terminal or a target terminal for a relay service through a network or a communication system. Here, the communication system or network may support one or a combination of various communication protocols such as a code division multiple access (CDMA), wideband CDMA (WCDMA), time division multiple access (TDMA), frequency division multiple access (FDMA), orthogonal frequency division multiplexing (OFDM), orthogonal frequency division multiple access (OFDMA), single carrier (SC)-FDMA, non-orthogonal multiple access (NOMA), or space division multiple access (SDMA).

That is, the identifier conflict handling apparatus 100 may be implements as a computing device, as a type of communication node including one node selected from a relay, a base station, and the like.

The exemplary embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. A method of handling an identifier conflict in a relay communication access service using wireless direct communications, the method comprising:
receiving a relay communication request message from a remote terminal;
obtaining an identifier of the remote terminal from the relay communication request message;
assigning preliminary identifier(s) for identifier conflict handling based on the identifier of the remote terminal; and
transmitting a relay communication response message including preliminary identifier information for the assigned preliminary identifier(s) to the remote terminal.

2. The method according to claim 1, further comprising:
receiving a relay communication message from the remote terminal; and
identifying whether the identifier of the remote terminal included in the relay communication message matches one preliminary identifier selected from among the assigned preliminary identifier(s).

3. The method according to claim 2, further comprising, after the identifying, releasing reservations for remaining preliminary identifier(s) excluding the matched preliminary identifier among the assigned preliminary identifier(s).

4. The method according to claim 1, further comprising:
receiving an identifier update message from the remote terminal;
determining whether the a to-be-updated identifier of the remote terminal included in the identifier update message overlaps an identifier of another terminal in another relay service;
in response to determining that the to-be-updated identifier overlaps an identifier of another terminal, assigning preliminary update identifiers based on the to-be-updated identifier; and
transmitting, to the remote terminal, a message including preliminary update identifier information for the assigned preliminary update identifier(s) as a response message or a rejection message to the identifier update message.

5. The method according to claim 4, further comprising:
receiving a relay communication message from the remote terminal; and
identifying whether the identifier of the remote terminal included in the relay communication message matches one preliminary update identifier selected from among the assigned preliminary update identifier(s).

6. The method according to claim 5, further comprising, after the identifying, releasing reservations for remaining preliminary update identifier(s) excluding the matched preliminary updated identifier among the assigned preliminary update identifier(s).

7. The method according to claim 4, wherein the relay communication response message, the response message, or the rejection message includes additional fields for the preliminary identifier information.

8. The method according to claim 1, wherein the preliminary identifier is a connection layer identifier of the remote terminal and is composed of an identifier of an upper layer which is a Layer 2 (L2) and an identifier of a physical layer which is a lower layer.

9. The method according to claim 1, further comprising:
receiving an identifier update message from the remote terminal during a relay service for the remote terminal;
determining whether a to-be-updated identifier of the remote terminal included in the identifier update message is duplicate with an identifier of another terminal in another relay service;
in response to determining that the to-be-updated identifier overlaps an identifier of another terminal, assigning preliminary update identifier(s) based on the to-be-updated identifier; and
transmitting, to the remote terminal, a message including preliminary update identifier information for the assigned preliminary update identifier(s) as a response message to the identifier update message.

10. The method according to claim 9, further comprising:
receiving a relay communication message from the remote terminal within a predetermined time after transmitting the message including the preliminary update identifier information to the remote terminal; and
identifying whether the identifier of the remote terminal included in the relay communication message matches one preliminary update identifier selected from among the assigned preliminary update identifier(s).

11. The method according to claim 10, further comprising, after the identifying, releasing reservations for remaining preliminary update identifier(s) excluding the matched preliminary updated identifier among the assigned preliminary update identifier(s).

12. A method of handling an identifier conflict, performed by a remote terminal, in a relay communication access service using wireless direct communications, the method comprising:
transmitting a relay communication request message to a relay terminal;
receiving, from the relay terminal, a relay communication response message including preliminary identifier information for preliminary identifier(s) assigned for identifier conflict handling based on an identifier of the remote terminal;
selecting one preliminary identifier from among the preliminary identifier(s) according to a preconfigured scheme; and
transmitting a relay communication message to the relay terminal based on the selected preliminary identifier.

13. The method according to claim 12, wherein the relay communication response message includes additional fields for the preliminary identifier information.

14. The method according to claim 12, wherein the preliminary identifier is a connection layer identifier of the remote terminal and is composed of an identifier of an upper layer which is a Layer 2 (L2) and an identifier of a physical layer which is a lower layer.

15. An apparatus for handling an identifier conflict in a relay communication access service using wireless direct communications, the apparatus comprising:
a processor;
instructions executable by the processor; and
a memory storing the instructions,
wherein when executed by the processor, the instructions cause the processor to:
receive a relay communication request message from a remote terminal;
obtain an identifier of the remote terminal from the relay communication request message;
assign preliminary identifier(s) for identifier conflict handling based on the identifier of the remote terminal; and
transmit a relay communication response message including preliminary identifier information for the assigned preliminary identifier(s) to the remote terminal.

16. The apparatus according to claim 15, wherein the instructions further cause the processor to:
receive a relay communication message from the remote terminal; and
identify whether the identifier of the remote terminal included in the relay communication message matches one preliminary identifier selected from among the assigned preliminary identifier(s).

17. The apparatus according to claim 16, wherein the instructions further cause the processor to, after the identifying, release reservations for remaining preliminary identifier(s) excluding the matched preliminary identifier among the assigned preliminary identifier(s).

18. The apparatus according to claim 15, wherein the instructions further cause the processor to:
receive an identifier update message from the remote terminal;
determine whether the a to-be-updated identifier of the remote terminal included in the identifier update message overlaps an identifier of another terminal in another relay service;
in response to determining that the to-be-updated identifier overlaps an identifier of another terminal, assign preliminary update identifiers based on the to-be-updated identifier; and
transmit, to the remote terminal, a message including preliminary update identifier information for the assigned preliminary update identifier(s) as a response message or a rejection message to the identifier update message.

19. The apparatus according to claim 18, wherein the instructions further cause the processor to:
receive a relay communication message from the remote terminal; and
identify whether the identifier of the remote terminal included in the relay communication message matches one preliminary update identifier selected from among the assigned preliminary update identifier(s).

20. The apparatus according to claim 19, wherein the instructions further cause the processor to, after the identifying, release reservations for remaining preliminary update identifier(s) excluding the matched preliminary updated identifier among the assigned preliminary update identifier(s).
